(19) United States
(12) Patent Application Publication
(10) Pub. No.: US 2004/0072716 A1
(43) Pub. Date: Apr. 15, 2004

(54) Cleaner formulation that prevent the discoloration of plastic articles

(76) Inventors: Axel Kistenmacher, Bad Durkheim (DE); Stephan Nied, Hanhofen (DE); Marcus Guzmann, Leimen (DE); Ralf Wiedemann, Griesheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/470,915

(22) PCT Filed: Jan. 30, 2002
(86) PCT No.: PCT/EP02/00962

(30) Foreign Application Priority Data
Feb. 1, 2001 (DE) 10104470.4

(51) Int. Cl. C11D 3/37

(52) U.S. Cl. 510/475

(57) ABSTRACT

The invention relates to cleaning formulations and to the use of the cleaning formulations for preventing the discoloration of plastic articles during washing in machine dishwashers.

The cleaning formulations comprise the following components:

a) copolymers containing

a1) from 10 to 60% by weight of at least one monomer unit (A) from the group of the monoethylenically unsaturated C₃-C₁₀ monocarboxylic and dicarboxylic acids or their anhydrides,

a2) from 40 to 90% by weight of at least one monomer unit (B) of the formula (I)

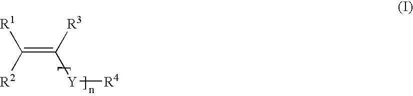

where R¹, R² and R³ independently of one another are H, CH₃, C₂H₅, C₃H₇, COOH or OH,

Y is —C(═O)—, —C(═O)—O—, —O—, —O—C(═O)—, —O—C(═O)—O— or —C(═O)—NH—,

n is 0 or 1, and

R⁴ is a linear or branched, cyclic or acyclic aliphatic radical having from 7 to 100 carbon atoms, and

a3) from 0 to 30% by weight of at least one further monomer unit (C) copolymerizable with the monomer units (A) and (B) and from the group consisting of C₁-C₆ (meth)acrylic esters, C₁-C₆ vinyl esters, C₂-C₈ olefins, styrenes, acrylonitriles, acrylamides, vinylformamides, allyl alcohols, vinylphosphonates, vinyl-substituted heterocycles and unsaturated organosulfonic acids,

b) a bleaching system comprising at least one component from the group consisting of bleach, bleach activator and bleaching catalyst.

The invention relates to cleaning formulations comprising certain copolymers, specified in the text, and to the use of the cleaning formulations for preventing the discoloration of plastic articles during cleaning in machine dishwashers.

Detergents for use in dishwashers are supplied in numerous variations with regard to their composition and to their mode of action. Among others, the customer is able to choose between universal cleaners or detergents suited specifically to problem ware. A distinction is also made between detergents for the household and for the commercial sector. Products for hand dishwashing constitute a further group of specialty detergents. These specific cleaning formulations feature proportions of components that are tailored to the particular ware, and they permit, for example, improved cleaning and/or gentler wash conditions as compared with universal cleaners. In the course of washing, particular problems are presented by the formation of films and spots on glasses, the discoloration of plastic articles, and the removal of fatty or oily food residues.

EP-A 462 829 discloses a chlorine-free cleaning composition for use in dishwashers which is suitable for preventing film formation and spotting on glasses. Cleaning product ingredients described as relevant for this purpose are exclusively copolymers composed of the monomer maleic acid, its anhydride or a salt of maleic acid, and at least one polymerizable monomer. This monomer is from the group of the alkanes, alkenes, dienes, alkynes or aromatics having in each case at least 4 carbon atoms, particularly isobutylene, diisobutylene, styrene, decene or eicosene.

WO 98/26 036 describes a cleaning composition specifically for hand dishwashing that prevents the attachment of fats or oils to the surface of the ware. The relevant cleaning product ingredient used for this purpose comprises polymers having a hydrophilic parent structure and hydrophobic side chains. The hydrophilic parent structure may be negatively charged or neutral; examples of suitable monomers include (meth)acrylic acid, crotonic acid, acrolein, and vinyl methyl ether; and hydrophobic side chains used comprise saturated or unsaturated alkyl chains having from 5 to 24 carbon atoms.

Colored food constituents are found to be highly problematic especially when washing plastic articles in dishwashers. The majority of cleaning formulations lack sufficient ability to remove colored food constituents completely from the surface of the plastic articles and/or to prevent the reattachment of previously detached residues at other sites on the plastic articles to be washed. U.S. Pat. No. 5,827,808 describes in this respect a cleaning composition comprising cellulose ethers for the purpose of preventing this discoloration. The cleaning composition is especially suitable for use in dishwashers.

The problem of the staining of plastic articles by colored food constituents in dishwashers has not been solved satisfactorily to date.

It is an object of the present invention to provide cleaning formulations which ensure effective prevention of the discoloration of plastic articles by colored food constituents during washing in dishwashers.

We have found that this object is achieved by the use of cleaning formulations which comprise copolymers and, if desired, a bleaching system.

The copolymers contain

a) from 10 to 60% by weight of at least one monomer unit (A) from the group of the monoethylenically unsaturated C₃-C₁₀monocarboxylic and dicarboxylic acids or their anhydrides,

b) from 40 to 90% by weight of at least one monomer unit (B) of the formula (I)

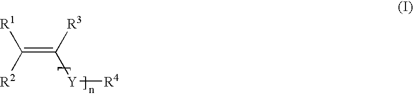

where R¹, R² and R³ independently of one another are H, CH₃, C₂H₅, C₃H₇, COOH or OH,

Y is —C(═O)—, —C(═O)—O—, —O—, —O—C(═O)—, —O—C(═O)—O— or —C(═O)—NH—,

n is 0 or 1, and

R⁴ is a linear or branched, cyclic or acyclic aliphatic radical having from 7 to 100 carbon atoms,

c) from 0 to 30% by weight of at least one further monomer unit (C) copolymerizable with the monomer units (A) and (B) and from the group consisting of C₁-C₆ (meth)acrylic esters, C₁-C₆ vinyl esters, C₂-C₈ olefins, styrenes, acrylonitriles, acrylamides, vinylformamides, allyl alcohols, vinylphosphonates, vinyl-substituted heterocycles and unsaturated organosulfonic acids.

The bleaching system comprises at least one component from the group consisting of bleach, bleach activator and bleaching catalyst.

The use in accordance with the invention of the cleaning formulations described above effectively prevents the discoloration of plastic articles caused by colored food constituents during washing in dishwashers. An advantage is that the cleaning formulations can be used to clean plastic articles in dishwashers both for the household sector and for the commercial sector, which is not the case with numerous commercial detergents.

EP-A 462 829 discloses cleaning formulations comprising copolymers some of which fall within the above-defined range of the copolymers of the cleaning formulations of the invention. In contrast to the present invention, however, the cleaning formulations of EP-A 462 829 contain no bleaching system, and the presence of chlorine bleach is explicitly excluded. Nor does EP-A 462 829 disclose the possibility of using the cleaning formulations and copolymers described therein to prevent the discoloration of plastic articles.

During washing, conventional detergents detach from the sites in question colored food residues that adhere to parts of the dirty ware introduced. The dishwasher distributes the detached food residues over the entirety of the ware present within the dishwasher in question, with at least some of the colored food residues reattaching to the ware, especially to plastic articles.

The use of the cleaning formulations in accordance with the invention, in contrast, by virtue of the copolymers they comprise, prevents the reattachment of colored food residues and/or the dyes they comprise on the plastic articles that are to be washed. For this reason, the often irreversible discoloration to the plastic articles that is caused by the dirt load that is introduced, as a result of washing, is not observed.

Additionally to the copolymers, the cleaning formulations may comprise a bleaching system. The bleaching system frequently supports the copolymers' effect of reducing color transfer. Cleaning formulations comprising both copolymers and a bleaching system frequently exhibit an improved cleaning effect as compared with the same cleaning formulation without a bleaching system. The effect of reducing color transfer by cleaning formulations which comprise a bleaching system but no copolymers is generally poorer than that of cleaning formulations comprising copolymers but no bleaching system. A bleaching system comprises at least one component from the group consisting of bleach, bleach activator and bleaching catalyst. Examples of suitable bleaches, bleach activators and bleaching catalysts that may be used in the cleaning formulations of the invention are set out later on below in the text.

The above-described copolymers contain from 10 to 60% by weight of at least one monomer unit (A) from the group of the monoethylenically unsaturated C₃-C₁₀ monocarboxylic and dicarboxylic acids or their anhydrides.

Examples of suitable monomer units (A) include acrylic acid, methacrylic acid, maleic acid, maleic anhydride, fumaric acid, itaconic acid, citraconic acid, methylenemalonic acid and crotonic acid.

In one preferred embodiment of the present invention the monomer unit (A) used comprises maleic acid, maleic anhydride and/or acrylic acid.

The copolymers further contain from 40 to 90% by weight of at least one monomer unit (B) of the formula (I)

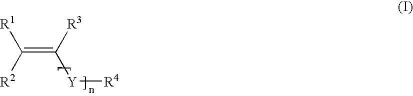

where R¹, R² and R³ independently of one another are H, CH₃, C₂H₅, C₃H₇, COOH or OH,

Y is —C(═O)—, —C(═O)—O—, —O—, —O—C(═O)—, —O—C(═O)—O— or —C(═O)—NH—,

n is 0 or 1, and

R⁴ is a linear or branched, cyclic or acyclic aliphatic radical having from 7 to 100 carbon atoms.

Examples of suitable monomer units (B) embrace groups of substances listed below.

α-Olefins having 10 or more carbon atoms, such as 1-decene, 1-dodecene, 1-hexadecene, 1-octadecene and C₂₂ α-olefin, for example, preferably 1-dodecene, 1-octadecene or C₂₂ α-olefin;

olefin mixtures of α-olefins having from 10 to 28 carbon atoms, such as C₁₀-C₁₂ α-olefins (α-olefins having 10 or 12 carbon atoms), C₁₂-C₁₄ α-olefins, C₁₄-C₁₈ α-olefins, C₂₀-C₂₄ α-olefins, C₂₄-C₂₈ α-olefins, for example, preferably C₂₀-C₂₄ α-olefins;

olefin mixtures of at least two different α-olefins having 30 or more carbon atoms, such as C₃₀+α-olefins (olefin mixture of C₃₀ α-olefin and at least one further α-olefin having an even number of carbon atoms greater than 30), for example;

polyisobutenes having on average from 12 to 100 carbon atoms and an α-olefin fraction of more than 80%, such as polyisobutene 1000 (polyisobutene having an average molar mass of 1000), for example;

ethylhexyl(meth)acrylate, lauryl(meth)acrylate, stearyl(meth)acrylate, vinyl dodecenoate, vinyl stearate, dodecyl vinyl ether and octadecyl vinyl ether.

The copolymers may contain at least one further monomer unit (C), accounting for from 0 to 30% by weight of the overall weight of the copolymer.

Suitable monomer units (C) copolymerizable with the monomer units (A) and (B) include, for example, the groups of substances listed below.

C₁-C₆ (meth)acrylic esters such as methyl acrylate, ethyl acrylate, methyl methacrylate, ethyl methacrylate, butyl(meth)acrylate, hydroxyethyl(meth)acrylate, hydroxypropyl(meth)acrylate and alkylpolyethylene glycol (meth)acrylate, for example;

C₁-C₆ vinyl esters such as vinyl formate, vinyl acetate and vinyl propionate, for example;

C₂-C₈ olefins such as ethene, propene, butene, isobutene, pentene, cyclopentene, hexene, cyclohexene, 1-octene or (technical-grade) diisobutene, for example, preferably cyclopentene, hexene or technical-grade diisobutene;

styrenes, acrylonitriles, acrylamides, vinylformamides, allyl alcohols and vinyl phosphonates;

vinyl-substituted heterocycles such as N-vinylpyrrolidone or N-vinylcaprolactam, for example;

unsaturated organosulfonic acids such as styrenesulfonic acid, 2-acrylamido-2-methylpropanesulfonic acid, vinylsulfonic acid and methallylsulfonic acid, for example.

The copolymers may be used in the form of the free acid, a salt thereof, or the anhydride; they may also be present in partly neutralized form. In particular the copolymers may be present in the form of their sodium, potassium or ammonium salts.

The copolymers may be subjected to an additional reaction. Examples of such reactions are esterifications with C₁-C₂₀ alcohols, alkylpolyalkylene glycols such as methylpolyethylene glycol having an average degree of ethoxylation of 45 or alkylpolyethylene glycol-blockpolypropylene glycols such as methylpolyethylene glycol-block-polypropylene glycol containing 40 ethylene oxide units and 5 propylene oxide units, for example. This reaction may likewise be carried out with C₁-C₂₀ amines or alkylpolyalkylene glycol amines such as methylpolyethylene glycol amine having an average degree of ethoxylation of 8, with the formation of amide linkages.

The weight-average molecular weight of the copolymers is from 1 000 to 200 000, preferably from 2 000 to 50 000, with particular preference from 2 000 to 20 000. The copolymers are prepared by processes known to the skilled worker.

One preferred embodiment of the present invention comprises using copolymers comprising as monomer unit (A) maleic acid and/or maleic anhydride and at least one monomer unit (B) from the group consisting of 1-dodecene, C₂₂ α-olefin, C₂₀-C₂₄ α-olefins and polyisobutene 1000. Particular preference is given to using copolymers comprising as monomer unit (A) maleic anhydride and as monomer unit (B) 1-dodecene, C₂₂ α-olefin, C₂₀-C₂₄ α-olefins, a mixture of 1-dodecene with polyisobutene 1000 or a mixture of 1-dodecene with C₂₀-C₂₄ α-olefins.

In another preferred embodiment of the present invention the copolymers are in the form of their alkali metal salt or ammonium salt, with particular preference in the form of their sodium salt or ammonium salt.

In another preferred embodiment of the present invention the copolymers contain from 10 to 40% by weight of the monomer unit (A).

The copolymer content of the cleaning formulation is from 0.01 to 10% by weight, preferably from 0.05 to 5% by weight, with particular preference from 0.1 to 5% by weight, based on the overall weight of the cleaning formulation.

The copolymers may be used in the form of their aqueous solutions or dispersions. Additionally, the copolymers may also be used in solid form, as powders or granules, for example. These are obtainable, for example, by spray drying with possible subsequent compaction or by spray granulation. In the course of drying it is possible to incorporate—in the sense of cogranulation—further water-soluble substances such as sodium sulfate, sodium chloride, sodium acetate, sodium citrate, pentasodium triphosphate, sodium carbonate, sodium hydrogen carbonate or polymers such as polyacrylates, polyacrylic acid, polyvinyl alcohol, Sokalan® CP 5 (copolymer containing polyacrylic acid and maleic acid as monomer units), cellulose and its derivatives, and sugars and their derivatives. Additionally, substances soluble poorly in water if at all may also be incorporated and/or used as carrier substances, such as zeolites and precipitated silicas. Particularly suitable (cogranulated) granules are those comprising copolymers and from 10 to 50% by weight of sodium sulfate, sodium carbonate, sodium hydrogen carbonate and/or polyacrylates.

In accordance with the invention the copolymers may be used in liquid, gel, powder, granular and tableted cleaning formulations. It is possible to incorporate copolymers, together if desired with other formulation ingredients, into particular compartments such as microcapsules or gel capsules. Moreover, the copolymers may also be built into specific compartments within dishwasher detergent tablets, which may where appropriate differ in their dissolution properties from the other compartments of the tablet. These compartments may include both specific tablet layers and specific shapes sunk into the tablet, bonded adhesively to the tablet, or enveloped by the tablet.

Suitable bleaches, bleach activators and bleaching catalysts that may be used in the bleaching system of the cleaning formulations of the invention are set out hereinbelow.

Bleaches

Bleaches subdivide into oxygen bleaches and chlorine bleaches. Oxygen bleaches used include alkali metal perborates and their hydrates, and alkali metal percarbonates.

Preferred bleaches here are sodium perborate in the form of the monohydrate or tetrahydrate, sodium percarbonate, or the hydrates of sodium percarbonate.

Likewise suitable for use as oxygen bleaches are persulfates and hydrogen peroxide.

Typical oxygen bleaches also include organic peracids such as perbenzoic acid, peroxy-alpha-naphthoic acid, peroxylauric acid, peroxystearic acid, phthalimidoperoxycaproic acid, 1,12-diperoxydodecanedioic acid, 1,9-diperoxyazelaic acid, diperoxoisophthalic acid or 2-decyldiperoxybutane-1,4-dioic acid.

Moreover, the following oxygen bleaches may also find application in the cleaning formulation:

cationic peroxy acids which are described in the patent applications U.S. Pat. No. 5,422,028, U.S. Pat. No. 5,294,362 and U.S. Pat. No. 5,292,447;

sulfonylperoxy acids which are described in the patent application U.S. Pat. No. 5,039,447.

Oxygen bleaches are used in amounts of from 0.5 to 30% by weight, preferably from 1 to 20% by weight, with particular preference from 3 to 15% by weight, based on the overall cleaning formulation.

Chlorine bleaches and also the combination of chlorine bleaches with peroxide bleaches may likewise be used. Examples of known chlorine bleaches include 1,3-dichloro-5,5-dimethylhydantoin, N-chlorosulfamide, chloramine T, dichloramine T, chloramine B, N,N′-dichlorobenzoylurea, dichloro-p-toluenesulfonamide and trichloroethylamine. Preferred chlorine bleaches are sodium hypochlorite, calcium hypochlorite, potassium hypochlorite, magnesium hypochlorite, potassium dichloroisocyanurate or sodium dichloroisocyanurate.

Chlorine bleaches are used in amounts of from 0.1 to 20% by weight, preferably from 0.2 to 10% by weight, with particular preference from 0.3 to 8% by weight, based on the overall cleaning formulation.

It is also possible to add small amounts of bleach stabilizers such as phosphonates, borates, metaborates, metasilicates or magnesium salts, for example.

Bleach Activators

Bleach activators are compounds which under perhydrolysis conditions give aliphatic peroxocarboxylic acids having preferably 1 to 10 carbon atoms, in particular from 2 to 4 carbon atoms, and/or substituted perbenzoic acid. Suitable compounds are those containing one or more N- and/or O-acyl groups and/or substituted or unsubstituted benzoyl groups, such as substances from the class of the anhydrides, esters, imides, acylated imidazoles or oximes. Examples are tetraacetylethylenediamine (TAED), tetraacetylmethylenediamine (TAMD), tetraacetylglycoluril (TAGU), tetraacetylhexylenediamine (TAHD), N-acyl imides, such as N-nonanoylsuccinimide (NOSI), acylated phenolsulfonates, such as n-nonanoyl- or isononanoyloxybenzenesulfonates (n- or iso-NOBS) for example, pentaacetylglucose (PAG), 1,5-diacetyl-2,2-dioxohexahydro-1,3,5-triazine (DADHT) or isatoic anhydride (ISA).

Suitable bleach activators likewise include nitrile quats such as N-methylmorpholinium-acetonitrile salts (MMA salts) or trimethylammoniumacetonitrile salts (TMAQ salts), for example.

Suitable bleach activators preferably include those from the group consisting of polyacylated alkylenediamines, with particular preference TAED, N-acylimides, with particular preference NOSI, acylated phenolsulfonates, with particular preference n- or iso-NOBS, MMA, and TMAQ.

Additionally, the following substances may find application as bleach activators in the cleaning formulation:

carboxylic anhydrides such as phthalic anhydride;

acylated polyhydric alcohols such as triacetin, ethylene glycol diacetate or 2,5-diacetoxy-2,5-dihydrofuran;

the enol esters known from DE-A 196 16 693 and DE-A 196 16 767, and also acetylated sorbitol and mannitol and their mixtures described in EP-A 525 239;

acylated sugar derivatives, especially pentaacetylglucose (PAG), pentaacetylfructose, tetraacetylxylose and octaacetyllactose, and also acetylated, unalkylated or N-alkylated glucamine and gluconolactone, and/or N-acylated lactams, such as N-benzoylcaprolactam, which are known from the documents WO 94/27 970, WO 94/28 102, WO 94/28 103, WO 95/00 626, WO 95/14 759, and WO 95/17 498;

the hydrophilically substituted acyl acetals set out in DE-A 196 16 769, and also the acyl lactams described in DE-A 196 16 770 and WO 95/14 075, may be used in the same way as the combinations of conventional bleach activators known from DE-A 44 43 177.

Bleach activators are used in amounts of from 0.1 to 10% by weight, preferably from 1 to 9% by weight, with particular preference from 1.5 to 8% by weight, based on the overall cleaning formulation.

Bleaching Catalysts

In addition to or instead of the conventional bleach activators listed above, the cleaning formulations of the invention may also include bleach-boosting transition metal salts or transition metal complexes and/or sulfone imines known from EP-A 446 982 and EP-A 453 003, these compounds being known as bleaching catalysts.

The transition metal compounds in question include, for example, the manganese, iron, cobalt, ruthenium or molybdenum salen complexes known from DE-A 195 29 905 and their N-analog compounds known from DE-A 196 20 267; the manganese, iron, cobalt, ruthenium or molybdenum carbonyl complexes known from DE-A 195 36 082; the manganese, iron, cobalt, ruthenium, molybdenum, titanium, vanadium and copper complexes with nitrogenous tripod ligands, described in DE-A 196 05 688; the cobalt, iron, copper and ruthenium ammine complexes known from DE-A 196 20 411; the manganese, copper and cobalt complexes described in DE-A 44 16438; the cobalt complexes described in EP-A 272 030; the manganese complexes known from EP-A 693 550; the manganese, iron, cobalt and copper complexes known from EP-A 392 592; and/or the manganese complexes described in EP-A 443 651, EP-A 458 397, EP-A 458 398, EP-A 549 271, EP-A 549 272, EP-A 544490 and EP-A 544 519. Combinations of bleach activators and transition metal bleaching catalysts are known, for example, from DE-A 196 13 103 and WO 95/27 775.

Dinuclear manganese complexes containing 1,4,7-trimethyl-1,4,7-triazacyclononane (TMTACN), such as [(TMTACN)₂Mn^{IV}Mn^{IV}(μ-O)₃]²⁺(PF₆⁻)₂, for example, are likewise suitable as effective bleaching catalysts. These manganese complexes are likewise described in the aforementioned documents.

Suitable bleaching catalysts include preferably bleach-boosting transition metal complexes or transition metal salts from the group consisting of the salts and complexes of manganese and the salts and complexes of cobalt. With particular preference they include the cobalt ammine complexes, the cobalt acetato complexes, the cobalt carbonyl complexes, the chlorides of cobalt or manganese, manganese sulfate or [(TMTACN)₂Mn^{IV}Mn^{IV} (μ-O)₃]²⁺(PF₆⁻)₂.

Bleaching catalysts are used in amounts of from 0.0001 to 5% by weight, preferably from 0.0025 to 1% by weight, with particular preference from 0.01 to 0.25% by weight, based on the overall cleaning formulation.

In accordance with the invention the cleaning formulations may be used for any kind of plastic article. Examples of common plastics found in the household or in the commercial sector include polyethylene, polypropylene, polystyrene, polycarbonate, styrene-acrylonitrile plastics, styrene-butadiene plastics, acrylonitrile-butadiene-styrene plastics, acrylonitrile-styrene-acrylate plastics, polyvinyl chloride, polytetrafluoroethylene, polyoxymethylene, polyphenylene oxide, polymethyl methacrylate, polyethylene terephthalate, polybutylene terephthalate, polyamides, phenol-formaldehyde plastics, urea-formaldehyde plastics, and melamine-formaldehyde plastics. A preferred use of the cleaning formulations, in accordance with the invention, is for plastic articles of polyethylene (LDPE, LLDPE) and polypropylene.

Types of soil loading which are critical in the sense of unwanted discolorations of plastic include all types of colored food residues. By way of example, mention may be made of food residues of tomatoes, tomato ketchup, tomato puree, rosehips, carrots, red pepper, saffron, capsicum, paprika, or spinach, rosehip tea, and also fruit and vegetable juices such as orange juice, tomato juice, carrot juice or cherry juice. The carotenoid dyes these foods (in part) contain, such as β-carotene, lycopene, zeaxanthin, canthaxanthin, cryptoxanthin, rhodoxanthin, crocetin, capsorubin or β-citraurin, are regarded as the principal culprits in instances of discoloration of plastics.

The use of the cleaning formulation in accordance with the invention is to be seen in particular in the prevention of the discoloration of plastic articles that may be caused by the aforementioned food residues, especially those containing carotenoids.

Besides the above-described copolymers and, where appropriate, the bleaching system, the cleaning formulations of the invention normally include other added components known to the skilled worker. Examples of these are set out below.

Builders

Both water-soluble and water-insoluble builders may be used, their principal function being to bind calcium and magnesium. Customary builders, which may by present in the cleaning formulation at from 10 to 90% by weight, based on the overall preparation, include, for example, phosphates such as alkali metal phosphates and polymeric alkali metal phosphates, which may be present in the form of their alkaline, neutral or acidic ammonium, sodium or potassium salts.

Examples of these include trisodium phosphate, tetrasodium diphosphate, disodium dihydrogen phosphate, pentasodium tripolyphosphate, the compound known as sodium hexametaphosphate, oligomeric trisodium phosphate with degrees of oligomerization of from 5 to 1000, in particular from 5 to 50, and also the corresponding potassium salts, or mixtures of sodium hexametaphosphate and the corresponding potassium salts, or mixtures of sodium salts and potassium salts. These phosphates are preferably used in the range from 5% by weight to 65% by weight based on the overall formulation and calculated as anhydrous active substance.

The following may also be used as builders:

low molecular mass carboxylic acids and their salts, such as alkali metal citrates, especially anhydrous trisodium citrate or trisodium citrate dihydrate, alkali metal succinates, alkali metal malonates, fatty acid sulfonates, oxydisuccinate, alkyl- or alkenyldisuccinates, gluconic acids, oxadiacetates, carboxymethyloxysuccinates, tartrate monosuccinate, tartrate disuccinate, tartrate monoacetate, tartrate diacetate, and α-hydroxypropionic acid;

oxidized starches and oxidized polysaccharides;

homo- and copolymeric polycarboxylic acids and their salts, such as polyacrylic acid, polymethacrylic acid and copolymers of maleic acid and acrylic acid;

graft polymers of monoethylenically unsaturated monocarboxylic and/or dicarboxylic acids on monosaccharides, oligosaccharides, polysaccharides or polyaspartic acid;

aminopolycarboxylates and polyaspartic acid;

complexing agents and phosphonates and their salts, such as nitrilotriacetic acid, ethylenediaminetetraacetic acid, diethylenetriaminepentaacetic acid, hydroxyethylethylene-diaminetriacetic acid, methylglycinediacetic acid, 2-phosphono-1,2,4-butanetricarboxylic acid, aminotri(methylenephosphonic acid), 1-hydroxyethylene(1,1-diphosphonic acid), ethylenediarninetetramethylenephosphonic acid, hexamethylenediaminetetramethylenephosphonic acid or diethylenetriaminepentamethylenephosphonic acid;

silicates such as sodium disilicate and sodium metasilicate;

water-insoluble builders such as zeolites and crystalline phyllosilicates.

The crystalline phyllosilicates correspond in particular to the general formula NaMSiₓO₂ₓ₊₁*y H₂O, where M is sodium or hydrogen, x is a number from 1.9 to 22, preferably from 1.9 to 4, and y is a number from 0 to 33. Known examples include in particular α-Na₂Si₂O₅, β-Na₂Si₂O₅, and δ-Na₂Si₂O₅. Mixtures of the aforementioned builder substances are likewise included here. Preference is given to using trisodium citrate and/or pentasodium tripolyphosphate and/or sodium carbonate and/or sodium bicarbonate and/or gluconates and/or silicatic builders from the class of the disilicates and/or metasilicates.

Alkali Carriers

Further constituents of the cleaning formulation that may be present include alkali carriers. Alkali carriers are ammonium and/or alkali metal hydroxides, ammonium and/or alkali metal carbonates, ammonium and/or alkali metal hydrogen carbonates, ammonium and/or alkali metal sesquicarbonates, ammonium and/or alkali metal silicates, ammonium and/or alkali metal metasilicates, and mixtures of the aforementioned substances, preference being given to the use of ammonium and/or alkali metal carbonates, especially sodium carbonate, sodium hydrogen carbonate or sodium sesquicarbonate.

Preferred combinations of builder and alkali carrier are mixtures of tripolyphosphate and sodium carbonate or tripolyphosphate, sodium carbonate, and sodium disilicate.

Surfactants

As further component the cleaning formulation preferably includes low-foaming nonionic surfactants in proportions of from 0.1 to 20% by weight, preferably from 0.1 to 10% by weight, with particular preference from 0.25 to 4% by weight.

These are, for example, surfactants from the group of the fatty alcohol alkoxylates of the formula (II), which are available commercially, for example, under the product names Plurafac® (BASF Aktiengesellschaft), especially Plurafac LF 500, or Dehypon® (Cognis).

R²—O—(CH₂—CH₂—O)ₚ—(CHR¹—CH₂—O)ₘ—R³ (II)

where R¹ and R³ independently of one another are CₙH₂ₙ₊₁ and n is from 1 to 4,

R² is CₙH₂ₙ₊₁ and n is from 3 to 30, and

m and p independently of one another are from 0 to 300.

It is also possible to use diblock and multiblock copolymers composed of ethylene oxide and propylene oxide, which are available commercially, for example, under the name Pluronic® (BASF Aktiengesellschaft) or Tetronic® (BASF Corporation). Use may also be made of reaction products of sorbitan esters with ethylene oxide and/or propylene oxide. Likewise suitable are amine oxides or alkyl glycosides. An overview of several nonionic surfactants is given by EP-A 851 023 and also DE-A 198 19 187.

The formulation may further comprise anionic or zwitterionic surfactants, preferably in a blend with nonionic surfactants. Suitable anionic and zwitterionic surfactants are likewise specified in EP-A 851 023 and also DE-A 198 19 187.

Corrosion Inhibitors

In particular it is possible to use silver protectants from the group of triazoles, benzotriazoles, bisbenzotriazoles, aminotriazoles, alkylaminotriazoles and transition metal salts or transition metal complexes. Used with particular preference are benzotriazole and/or alkylaminotriazole. Furthermore, it is common in cleaning formulations to use active chlorine agents which are able to reduce significantly the corrosion of the silver surface. In chlorine-free cleaning products preference is given to using organic redox-active compounds containing oxygen and nitrogen, such as dihydric and trihydric phenols, e.g., hydroquinone, pyrocatechol, hydroxyhydroquinone, gallic acid, phioroglucinol, pyrogallol, and/or derivatives of these classes of compounds. Additionally, saltlike and complexlike inorganic compounds, such as salts of the metals Mn, Ti, Zr Hf, V, Co and Ce, frequently find application. Preference is given in this context to the transition metal salts selected from the group of manganese and/or cobalt salts and/or manganese and/or cobalt complexes, with particular preference from the group of the cobalt ammine complexes, cobalt acetato complexes, cobalt carbonyl complexes, the chlorides of cobalt or manganese, and manganese sulfate. Zinc compounds or bismuth compounds may similarly be used to prevent corrosion on the ware.

Enzymes

Between 0 and 5% by weight of enzymes, based on the overall preparation, may be added to the cleaning product in order to raise its performance or to ensure cleaning of equal quality under relatively mild conditions. Lipases, amylases, cellulases and proteases are among the enzymes most frequently used. It is also possible, for example, to use esterases, pectinases, lactases and peroxidases.

Examples of preferred proteases are BLAP® 140 (Biozym), Optimase® M-440 and Opticlean® M-250 (Solvay Enzymes), Maxacal® CX, Maxapem®, Esperase® (Gist Brocades), Savinase® (Novo) or Purafect OxP (Genencor). Particularly suitable cellulases and lipases are Celluzym® 0,7T and Lipolase® 30T (Novo Nordisk). Amylases used particularly include Duramyl®, Termamyl® 60 T and Termamyl® 90 T (Novo), Amylase-LT® (Solvay Enzymes), Maxamyl® P5000 (Gist Brocades) or Purafect® OxAm (Genencor).

### Further Additions

Liquid paraffins and silicone oils may optionally be used as defoamers and to protect plastic and metal surfaces. Defoamers are generally added in proportions of from 0.001% to 5%. Additionally, dyes such as Patent Blue, preservatives such as Kathon CG, perfumes and other fragrances may be added to the cleaning formulation.

In accordance with the invention, the copolymers may be used in cleaning formulations for both the household sector and the commercial sector. Commercial cleaners generally comprise a builder system based on pentasodium triphosphate, and/or sodium citrate and/or complexing agents such as nitrilotriacetate, for example. Unlike household cleaners, they frequently operate with sodium hydroxide or potassium hydroxide as alkali carriers. In addition, the bleaches used frequently include chlorine compounds such as sodium dichloroisocyanurate.

### EXAMPLES 1-14

### Description of Method for Testing Color Transfer Inhibition

### Pulverulent Detergent Formulations

The test of the efficacy of discoloration inhibitors in pulverulent cleaning formulations was carried out in a Bosch SMS 5062 dishwasher running the 65° C. heavy program with a water hardness of 9° dH [German hardness]. Cleaning formulations from Examples 1 to 6 and 7 to 12 were compared with one another. The cleaning formulations were dosed via the dosing compartment of the dishwasher at 40 g (Examples 1-6) and 20 g (Examples 7-12) in each case. At the beginning of the main wash cycle, 50 g of tomato ketchup were placed in the washing water of the dishwasher.

The plastic test articles used were polyethylene (commercial chopping board and freezer carton lid) and polypropylene (commercial freezer carton).

All figures in the tables for Examples 1 to 14 are in percent by weight. The designation discoloration inhibitor (DI) is that of copolymer 1 used in accordance with the invention to prevent the discoloration of plastic articles. Copolymer 1 has a weight-average molecular weight of 4500 and contains 25.5% by weight maleic anhydride as monomer unit (A) and 74.5% by weight of C₂₂ α-olefin as monomer unit (B). Copolymer 1 is in the form of the sodium salt. Enzymes used are amylase and protease in a 1:1 ratio.

TABLE 1

| Cleaning product | | | | | | |
|---|---|---|---|---|---|---|
| components | Example 1 | Example 2 | Example 3 | Example 4 | Example 5 | Example 6 |
| Discoloration inhibitor | 0.000 | 0.500 | 1.000 | 1.250 | 2.500 | 5.000 |
| Trisodium citrate | 25.000 | 25.000 | 25.000 | 25.000 | 25.000 | 25.000 |
| Sodium carbonate | 15.800 | 15.800 | 15.800 | 15.800 | 15.800 | 15.800 |
| Sodium bicarbonate | 52.200 | 51.700 | 51.200 | 50.950 | 49.700 | 47.200 |
| Phosphonate | 0.200 | 0.200 | 0.200 | 0.200 | 0.200 | 0.200 |
| Sodium percarbonate | 4.000 | 4.000 | 4.000 | 4.000 | 4.000 | 4.000 |
| TAED | 1.400 | 1.400 | 1.400 | 1.400 | 1.400 | 1.400 |
| Enzymes | 0.400 | 0.400 | 0.400 | 0.400 | 0.400 | 0.400 |
| Plurafac LF 500 | 0.850 | 0.850 | 0.850 | 0.850 | 0.850 | 0.850 |
| Benzotriazole | 0.150 | 0.150 | 0.150 | 0.150 | 0.150 | 0.150 |
| Total | 100.000 | 100.000 | 100.000 | 100.000 | 100.000 | 100.000 |

TABLE 2

| Cleaning product | | | | Example | Example | Example |
|---|---|---|---|---|---|---|
| components | Example 7 | Example 8 | Example 9 | 10 | 11 | 12 |
| Discoloration inhibitor | 0.000 | 0.500 | 1.000 | 1.250 | 2.500 | 5.000 |
| Disilicate | 2.700 | 2.700 | 2.700 | 2.700 | 2.700 | 2.700 |
| Sodium | 55.000 | 55.000 | 55.000 | 55.000 | 55.000 | 55.000 |
| tripolyphosphate | | | | | | |
| Sodium carbonate | 25.800 | 25.300 | 24.800 | 24.550 | 23.300 | 20.800 |
| Sodium bicarbonate | 2.200 | 2.200 | 2.200 | 2.200 | 2.200 | 2.200 |
| Sokalan CP 5 | 3.500 | 3.500 | 3.500 | 3.500 | 3.500 | 3.500 |
| Sodium percarbonate | 6.000 | 6.000 | 6.000 | 6.000 | 6.000 | 6.000 |
| TAED | 2.000 | 2.000 | 2.000 | 2.000 | 2.000 | 2.000 |
| Enzymes | 1.400 | 1.400 | 1.400 | 1.400 | 1.400 | 1.400 |
| Plurafac LF 500 | 1.000 | 1.000 | 1.000 | 1.000 | 1.000 | 1.000 |
| Benzotriazole | 0.250 | 0.250 | 0.250 | 0.250 | 0.250 | 0.250 |
| Perfume | 0.150 | 0.150 | 0.150 | 0.150 | 0.150 | 0.150 |
| Total | 100.000 | 100.000 | 100.000 | 100.000 | 100.000 | 100.000 |

Cleaning formulations in gel form

The testing of the efficacy of the discoloration inhibitor in gel-form cleaning formulations in Example 13 and 14 was carried out in a General Electric Profile dishwasher running the normal wash/heated dry program with a water hardness of 10° dH and a water entry temperature of 60° C. The cleaning formulations were each dosed at 45 g for the prewash cycle and 60 g for the main wash cycle, via the dosing compartment of the dishwasher. Before the start of the dishwash program, 50 g of tomato ketchup were placed in the dishwasher. The plastic test articles used were polyethylene (commercial chopping board and freezer carton lid) and polypropylene (commercial freezer carton).

TABLE 3

| | Example | Example |
|---|---|---|
| Cleaning product components | 13 | 14 |
| Discoloration inhibitor | 0.000 | 0.800 |
| Softened water | 81.650 | 80.850 |
| Kathon CG | 0.100 | 0.100 |
| Polyacrylate | 1.200 | 1.200 |
| Potassium tripolyphosphate | 6.000 | 6.000 |
| Sodium tripolyphosphate | 10.000 | 10.000 |
| Plurafac LF 500 | 0.200 | 0.200 |
| Perfume | 0.100 | 0.100 |
| Enzymes | 0.700 | 0.700 |
| Patent Blue | 0.050 | 0.050 |
| Total | 100.000 | 100.000 |

### Test Results

The color locus values a and b were measured at 10 defined points on the surfaces of each of the test items both before and after the washing cycle, using a Mahlo 4790-KI color locus measuring instrument. The color locus of the test surface is determined by averaging the measurements. Discoloration of the plastic test article corresponds to a shift in the color locus and may be depicted as a vector. The length of the vector is a measure of the discoloration of the surface. The percentage reduction in the length of the vector from the tests using the discoloration inhibitor (DI) as compared with the test without the discoloration inhibitor is a measure of the inhibition of discoloration (100%=no discoloration).

TABLE 4

| Exam- | Total | Inhibition on | Inhibition | Inhibition | |
|---|---|---|---|---|---|
| ple | amount | PE chopping | on PE | on PP | Inhibition |
| No. | of DI [g] | board [%] | lid [%] | carton [%] | average [%] |
| 1 | 0 | 0 | 0 | 0 | 0 |
| 2 | 0.2 | 49 | 28 | 37 | 38 |
| 3 | 0.4 | 53 | 59 | 42 | 51 |
| 4 | 0.5 | 85 | 79 | 79 | 81 |
| 5 | 1.0 | 90 | 93 | 72 | 85 |
| 6 | 2.0 | 92 | 96 | 85 | 91 |
| 7 | 0 | 0 | 0 | 0 | 0 |
| 8 | 0.1 | 35 | 28 | 58 | 40 |
| 9 | 0.2 | 44 | 32 | 59 | 45 |
| 10 | 0.25 | 79 | 57 | 74 | 70 |
| 11 | 0.5 | 90 | 81 | 75 | 82 |
| 12 | 1.0 | 92 | 89 | 80 | 87 |
| 13 | 0 | 0 | 0 | 0 | 0 |
| 14 | 0.84 | 81 | 47 | 52 | 60 |

It is evident from Table 4 that cleaning formulations comprising a discoloration inhibitor are able to effectively prevent the discoloration of plastic articles, unlike cleaning formulations containing no discoloration inhibitor. A comparison of Example 14 with Examples 4 and 5 and 11 and 12, respectively, also shows that cleaning formulations comprising a bleaching system in addition to the discoloration inhibitor are even better able to prevent the discoloration of plastic articles. In Examples 4 and 11, improved inhibition of discoloration is found on the plastic articles investigated despite the fact that the amount of discoloration inhibitor used is lower than in Example 14. The sole presence of a bleaching system (without discoloration inhibitor) does not lead to satisfactory results in preventing the discoloration of plastic articles (Ex. 1, 7).

### EXAMPLES 15-25

### Test Method

New commercial plastic articles from the household sector were washed in a commercial dishwasher together with a defined, dye-containing test stain which was introduced into the dishwasher separately in a 100 ml glass beaker. The cleaning formulation used was a commercial dishwashing detergent to which discoloration inhibitors were added in accordance with the invention. To evaluate the test, a reflectance measurement was carried out on the plastic articles at 4 points in each case before and after the wash cycle (b.w./a. w.). The test result was reported as the reflectance (ref.) after the wash cycle, expressed as a % of the initial value (100%=no discoloration). The averages were formed in each case of the different measurement points, the different plastic articles, and the repeat tests (total of 3 tests per example).

TABLE 5
Test parameters

| | |
|---|---|
| Cleaning for- | from Table 2, Ex. 7 |
| mulation (CF) | |
| Amount of CF | 20 g |
| Discoloration | from Table 6 |
| inhibitor (DI) | |
| Amount of DI | 2% by weight based on cleaning formulation (solids) |
| Dishwasher | Miele G 661 SC / G 686 SC |
| Test stain | 50 g of tomato ketchup |
| Water hardness | 17° dH |
| Temperature | 65° C. |
| Plastic articles | Polyethylene chopping board |
| | Polyethylene freezer carton lid |
| | Polypropylene freezer carton |
| Reflectance | ELREPHO 2000 ; d /8° ; 460 nm |
| measuring | |
| instrument | |
| Reflectance | Measurement points: carton = 8; lid = 4; board = 3 |
| measurement | |
| before and after | |
| the wash cycle | |
| Calculation of | % ref. = ref. (a.w.) × 100/ ref. (b.w.) |
| reflectance | Averaging of measurement points, test articles, and |
| | repeat |

TABLE 6
Results

| Example No. | Discoloration inhibitor (DI) | Reflectance [%] |
|---|---|---|
| 15 | Cop. 1-dodecene / MSA (63/37) | 90 |
| 16 | Cop. 1-dodecene / PIB / MSA (62/15/23), | 90 |
| | Na salt form | |
| 17 | Cop. 1-dodecene / PIB / MSA (57/24/19) | 91 |
| | Na salt form | |
| 18 | Cop. 1-dodecene / PIB / MSA (50/34/16) | 88 |
| | Na salt form | |
| 19 | Cop. 1-dodecene / PIB / MSA (43/43/14) | 94 |
| | Na salt form | |
| 20 | Cop. 1-dodecene / PIB / MSA (35/52/13) | 92 |
| | Na salt form | |
| 21 | Cop. 1-dodecene/ PIB / MSA (59/6/35) | 91 |
| | Na salt form | |
| 22 | Cop. C₂₀-C₂₄ α-olefins / MSA (76/24), | 95 |
| | Na salt form | |
| 23 | Cop. C₂₀-C₂₄ α-olefins / MSA (76/24), | 94 |
| | NH₄ salt form | |
| 24 | Cop. 1-dodecene / C₂₀-C₂₄ α-olefins / MSA (42/28/30) | 92 |
| 25 | no DI | 56 |

Data for the polymeric discoloration inhibitor in % by weight
Abbreviations: MSA: maleic anhydride, PIB: polyisobutene (average molar mass = 1000), Cop.: copolymer containing the stated monomer units.

Unlike the comparative examples (1, 7, 13, 25), where no discoloration inhibitor is used, all examples (2-6, 8-12, 14-24) where the discoloration inhibitor is used in accordance with the invention are observed to give a significant reduction in discoloration of all plastic surfaces investigated.

We claim:

1. The use of a cleaning formulation comprising the following components:
a) copolymers containing
a1) from 10 to 60% by weight of at least one monomer unit (A) from the group of the monoethylenically unsaturated C₃-C₁₀ monocarboxylic and dicarboxylic acids or their anhydrides,
a2) from 40 to 90% by weight of at least one monomer unit (B) of the formula (I) 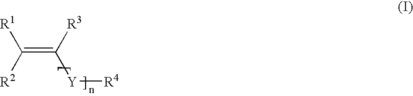
where R¹, R² and R³ independently of one another are H, CH₃, C₂H₅, C₃H₇, COOH or OH,
Y is —C(═O)—, —C(═O)—O—, —O—, —O—C(═O)—, —O—C(═O)—O— or —C(═O)—NH—,
n is 0 or 1, and
R⁴ is a linear or branched, cyclic or acyclic aliphatic radical having from 7 to 100 carbon atoms, and
a3) from 0 to 30% by weight of at least one further monomer unit (C) copolymerizable with the monomer units (A) and (B) and from the group consisting of C₁-C₆ (meth)acrylic esters, C₁-C₆ vinyl esters, C₂-C₈ olefins, styrenes, acrylonitriles, acrylamides, vinylformamides, allyl alcohols, vinylphosphonates, vinyl-substituted heterocycles and unsaturated organosulfonic acids,
b) a bleaching system comprising at least one component from the group consisting of bleach, bleach activator and bleaching catalyst.
for preventing the discoloration of plastic articles during washing in machine dishwashers.

2. The use as claimed in claim 1, wherein the monomer unit (A) is maleic acid, maleic anhydride and/or acrylic acid.

3. The use as claimed in claim 1 or 2, wherein the monomer unit (B) is 1-dodecene, 1-octadecene, polyisobutene 1000, C₂₂ α-olefin and/or an olefin mixture of C₂₀-C₂₄ α-olefins.

4. The use as claimed in any of claims 1 to 3, wherein the monomer unit (C) is cyclopentene, hexene and/or technical-grade diisobutene.

5. The use as claimed in any of claims 1 to 4, wherein the copolymers are used in the form of the free acid, a salt thereof, or the anhydride, especially in the form of the sodium salt or ammonium salt.

6. The use as claimed in any of claims 1 to 5, wherein the copolymers comprise as monomer unit (A) maleic anhydride and as monomer unit (B) 1-dodecene, C₂₂ α-olefin, C₂₀-C₂₄ α-olefins, a mixture of 1-dodecene with polyisobutene 1000 or a mixture of 1-dodecene with C₂₀-C₂₄ α-olefins and are in the form of the sodium salt or ammonium salt.

7. The use as claimed in any of claims 1 to 6, wherein the weight-average molecular weight of the copolymers is from 1 000 to 200 000, preferably from 2 000 to 50 000, with particular preference from 2 000 to 20 000.

8. The use as claimed in any of claims 1 to 7, wherein the copolymers are additionally reacted with alcohols or amines to form ester or amide linkages, respectively.

9. The use as claimed in any of claims 1 to 8, whose copolymer content is from 0.01 to 10% by weight, preferably from 0.05 to 5% by weight, with particular preference from 0.1 to 5% by weight.

10. The use as claimed in any of claims 1 to 9, wherein the copolymers are used in the form of aqueous solutions or aqueous dispersions, in solid form as powders or granules, or in the form of microcapsules or gel capsules.

11. The use as claimed in claim 10, wherein the granules comprise the copolymers and from 10 to 50% by weight of sodium sulfate, sodium carbonate, sodium hydrogen carbonate and/or polyacrylates.

12. The use as claimed in claim 10 or 11, wherein the copolymers are incorporated into certain compartments of said formulation and in the case of formulations in tablet form the compartments are, in particular, tablet layers and/or shapes let into the tablet, bonded to the tablet or enveloping the tablet.

13. The use as claimed in any of claims 1 to 12, wherein the bleach is sodium perborate in the form of the monohydrate or tetrahydrate, sodium percarbonate, the hydrates of sodium percarbonate, sodium hypochlorite, calcium hypochlorite, potassium hypochlorite, magnesium hypochlorite, potassium dichloroisocyanurate and/or sodium dichloroisocyanurate.

14. The use as claimed in any of claims 1 to 13, wherein the bleach activator is TAED, NOSI, n-NOBS, iso-NOBS, MMA and/or TMAQ.

15. The use as claimed in any of claims 1 to 14, wherein the bleaching catalyst is a cobalt am-mine complex, a cobalt acetato complex, a cobalt carbonyl complex, a chloride of cobalt, a chloride of manganese, manganese sulfate and/or [(TMTACN)₂Mn^{IV}Mn^{IV}(μ-O)₃]²⁺(PF₆⁻)₂.

16. The use as claimed in any of claims 1 to 15, wherein
a) at least one oxygen bleach at from 0.5 to 30% by weight, preferably from 1 to 20% by weight, with particular preference from 3 to 15% by weight, and/or
b) at least one chlorine bleach at from 0.1 to 20% by weight, preferably from 0.2 to 10% by weight, with particular preference from 0.3 to 8% by weight, and/or
c) at least one bleach activator at from 0.1 to 10% by weight, preferably from 1 to 9% by weight, with particular preference from 1.5 to 8% by weight, and/or
d) at least one bleaching catalyst at from 0.0001 to 5% by weight, preferably from 0.0025 to 1% by weight, with particular preference from 0.01 to 0.25% by weight,
are contained in the cleaning formulation.

17. The use of copolymers of the composition as defined in any of claims 1 to 8 to prevent the discoloration of plastic articles during washing in machine dishwashers.
